(19) United States
(12) Patent Application Publication
(10) Pub. No.: US 2025/0061511 A1
(43) Pub. Date: Feb. 20, 2025

(54) AUTOMATIC LOAN REPAYMENT FROM ASSETS

(71) Applicant: Wolfpack Financial Inc, Palo Alto, CA (US)

(72) Inventor: George Parthimos, Melbourne (AU)

(21) Appl. No.: 18/804,951

(22) Filed: Aug. 14, 2024

Related U.S. Application Data
(60) Provisional application No. 63/533,308, filed on Aug. 17, 2023.

(51) Int. Cl. G06Q 40/03; G06Q 40/06

(52) U.S. Cl. CPC G06Q 40/03; G06Q 40/06

(57) ABSTRACT

A method is provided for loan generation and management including generating a loan contract specifying payment terms including a payment amount and a due date for a payment in the payment amount. The method includes defining a linked account containing non-cash assets to be used for loan repayment. The method then determines that payment is due under the loan contract and defines a threshold required total asset value for the linked account. Upon confirming that an actual total asset value for the linked account is greater than the threshold required asset value, the method initiates payment of the payment amount under the loan contract. Such a payment may result in a negative cash balance associated with the linked account, and the method then initiates a sale of non-cash assets in the linked account to eliminate the negative cash balance. Also provided is a system for implementing the method.

### CROSS-REFERENCE TO RELATED APPLICATION

This application claims the benefit of U.S. Provisional Patent Application No. 63/533,308, filed Aug. 17, 2023, the contents of which are incorporated by reference herein in its entirety.

### FIELD OF THE INVENTION

This disclosure relates to systems and methods for automatic loan repayments from assets, namely repayment of loans from stock holdings.

### BACKGROUND

Many short-term loan products are available to consumers. Such loans may include margin loans, buy now pay later loans associated with a purchase, and personal loans. Personal loans may take many forms. Longer term loans may be made available as well, such as mortgages backed by a specific purchased item, such as a home. Each of these categories of loans has its own set of drawbacks. For example, unsecured loans typically require large amounts of due diligence by the lender, including credit checks.

Further, traditional margin loans may not include a repayment schedule, thereby exacerbating a reliance on market prices for assets under management. Accordingly, monitoring loan to value ratios over time is critical, and no repayment criteria necessarily exists. As such, margin loans may result in margin calls in the event of a fall in the value of assets, even where no payment is missed. The result is that funds available by way of a margin loan are somewhat unpredictable and can result of selloffs at precisely the time when asset values are lowest.

There is a need for a loan product that includes a defined repayment process, such that a user can avoid automatic selloffs of assets backing the underlying loan. There is a further need for a platform where such a loan product that can be generated based on defined criteria and with limited due diligence, such that loan seekers can be pre-approved and may leverage such the platform for point-of-sale purchases based on a buy now pay later product.

### SUMMARY

The invention relates to systems and methods for loan repayment for a loan product. Such a loan product may be used for purchase of stocks, personal loans, mortgages, buy now pay later platforms, etc., and may take many forms. For example, such a loan product may be integrated into a consumer purchase, such as by being linked to a debit card or credit card. Similarly, the loan product may be linked to a service payment, such as a monthly mobile or insurance bill.

This disclosure proposes a method and system that allows a user, such as a customer, to make a payment for goods or services through the automatic sell-down of shares as payment method. Such payment is by way of an automatically generated loan product, where the loan is then paid off by way of the automatic sell-down of assets backing the loan.

Existing payment methods typically use a bank account as the funding source and verification point for approving a payment. Under embodiments of the proposed system and method, the verification point is the share portfolio value. If the value of the share portfolio is equal to or greater than the agreed loan to value ratio (LVR), then the payment is made on behalf of the user and the shares are sold down at the next available trading day or over time to meet the repayment requirement.

As one example, if a user wants to buy stock shares using a platform implementing the method, the user can have the system purchase some number of shares with the funds in user's account added to a “booster” loan and set a repayment schedule (i.e., pay down monthly over the next year). At each repayment date, the system then sells some shares in order to fund the partial repayment. Similarly, the user can also link a credit card to his brokerage account, and after the user buys something, it can sell assets to cover it over time or at the next payment due date.

Accordingly, the loans issued in the system and method described herein may be point of sale short-term lending features which allow investors to use smart leverage to buy more stocks and pay them back over a preset schedule, such as a 10 week repayment schedule. Unlike margin loans, the loans described herein typically do not have margin calls. So long as the user continues their repayment schedule, the loan will continue to operate for the term.

Typically, the short-term loans described herein may use a maximum 50% loan to value ratio. Where the loan is used to purchase assets, such as a stock purchase, an investor must then fund 50% of the purchase up front.

In some embodiments, a method is provided for loan generation and management. Such a method may include generating a loan contract specifying payment terms, where the payment terms include a payment amount and at least one due date for a payment in the payment amount.

The method then includes defining a linked account, the linked account containing non-cash assets to be used for loan repayment. The method then determines that payment in the payment amount is due under the loan contract and defines a threshold required total asset value for the linked account.

Upon confirming that an actual total asset value for the linked account is greater than the threshold required asset value, the method includes initiating payment of the payment amount under the loan contract. Such a payment may result in a negative cash balance associated with the linked account. The method then initiates a sale of non-cash assets in the linked account, thereby eliminating the negative cash balance.

In some embodiments, upon eliminating the negative cash balance, the method continues to monitor payment due dates under the loan contract. Upon determining that payment in the payment amount is due under the loan contract, the method again defines a threshold required asset value for the linked account, confirms that an actual asset value for the linked account is greater than the threshold required asset value, initiates payment of the payment amount under the loan contract, and initiates a sale of assets in the linked account to eliminate any resulting negative cash balance.

In some embodiments, the total asset value for the linked account is a total value of assets nominated for use in securitization.

In some embodiments, the threshold required asset value for the linked account is defined based on a desired loan to value ratio. In some such embodiments, the desired loan to value ratio is 50%.

In some embodiments, the method includes receiving a request from a user for increased credit, determining that assets in the linked account are sufficient to support the increased credit, issuing the increased credit, and generating an updated loan contract specifying updated payment terms. The payment terms for the method are then redefined as the updated payment terms.

In some embodiments, the method further includes receiving a request for a loan prior to generating the loan contract. The request for a loan includes a desired loan amount. The method then defines a threshold required total asset value for the linked account based on the desired loan amount and confirms that an actual total asset value for the linked account is greater than the threshold required asset value. The method then generates the loan contract based on the request for the loan.

In some such embodiments, the request for a loan is automatically generated based on a purchase. In some such embodiments, the method for loan management is associated with a credit or debit card, and usage of the credit or debit card to execute a purchase automatically generates the request for a loan. In some other embodiments in which the request for a loan is automatically generated based on a purchase, the request for a loan is generated in a buy now pay later platform.

In some embodiments, the method includes determining that a user has attempted to purchase non-cash assets to be deposited in the linked account. The method then includes receiving a request for a loan prior to generating the loan contract, the request for a loan generated based on the attempted purchase of non-cash assets, and the request for a loan including a desired loan amount for purchasing the non-cash assets. The method then defines a threshold required total asset value for the linked account based on the desired loan amount.

The method then confirms that a hypothetical total asset value for the linked account is greater than the threshold required asset value, the hypothetical total asset value comprising a sum of an actual total asset value for the linked account and the non-cash assets associated with the attempted purchase. The method then proceeds to generate the loan contract based on the request for the loan.

In some such embodiments, the hypothetical total asset value for the linked account is a hypothetical value of the non-cash assets the user has attempted to purchase. The desired loan amount is then less than the value of the non-cash assets being purchased.

In some other embodiments relying on a hypothetical total asset value, the hypothetical total asset value for the linked account is a hypothetical value of the non-cash assets the user has attempted to purchase added to a value of assets already in the linked account nominated for securitization.

In some embodiments, the non-cash assets are stocks and the linked account is a brokerage account.

In some embodiments, the initiation of the sale of non-cash assets in the linked account is on the next available trading day.

In some embodiments, a system is provided for loan management. The system includes a memory for storing a plurality of instructions, processing circuitry implementing a loan system having a loan generation module and a loan repayment module, and a linked account accessible by the loan system.

The processing circuitry couples with the memory and is configured to execute the instructions to generate, at the loan generation module, a loan contract specifying payment terms, the payment terms comprising a payment amount and at least one due date for a payment in the payment amount. The system then defines, at the loan generation module, an association with the linked account, the linked account containing non-cash assets to be used for loan repayment.

The system then determines, at the loan repayment module, that payment in the payment amount is due under the loan contract and defines, at the loan repayment module, a threshold required total asset value for the linked account. The system then confirms, at the loan repayment module, that an actual total asset value for the linked account is greater than the threshold required asset value. The system then initiates payment by the loan repayment module of the payment amount under the loan contract, the payment resulting in a negative cash balance associated with the linked account, and initiates, by the loan repayment module, a sale of non-cash assets in the linked account, thereby eliminating the negative cash balance.

### BRIEF DESCRIPTION OF THE DRAWINGS

FIG. 1 illustrates a method for loan management in accordance with this disclosure.

FIG. 2 illustrates a method for generating a loan in the context of the method for loan management of this disclosure.

FIG. 3 illustrates a system for implementing the method of FIGS. 1 and 2.

FIG. 4 shows a schematic representation of a system architecture for implementing the methods described herein.

FIG. 5 shows a swim lane diagram for buying stock in a BNPL implementation in accordance with this disclosure. As shown, a user of the system may

FIG. 6 shows a swim lane diagram for repayment in a BNPL implementation in accordance with this disclosure.

FIG. 7 shows a swim lane diagram for evaluating user credit in a BNPL implementation in accordance with this disclosure.

FIG. 8 shows a swim lane diagram for selecting repayment variables in a loan contract in accordance with this disclosure.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

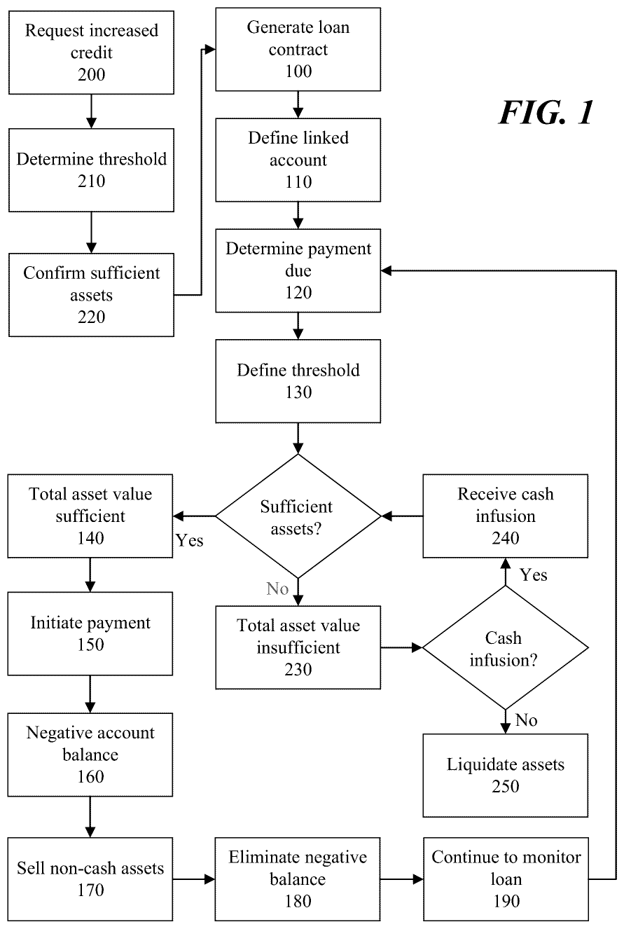

FIG. 1 illustrates a method for loan management in accordance with this disclosure. As shown, the method for loan management typically includes generating a loan contract (100) specifying payment terms. Such payment terms typically comprise a payment amount and at least one due date for a payment in the payment amount. Such payments may be recurring, such that the payment terms specify a monthly payment in the payment amount.

Once payment terms are defined, the method proceeds to define a linked account (110). The linked account contains non-cash assets to be used for loan repayment. As will be discussed in more detail below, the linked account may be a client brokerage account containing stocks to be used as collateral or to be used for securitization. Alternatively, the linked account may be an account defined or formed for the purpose of backing the loan. Accordingly, the loan may be formed as a result of a purchase of non-cash assets by a user, and the non-cash assets in the linked account are then the specific assets purchased using the loan. Alternatively, the linked account may be a cash account linked with the underlying platform. It is noted that when the method is indicated as defining a linked account, it does not necessarily mean creating the account. Accordingly, such a definition may be for the purpose of implementing the method, and may thereby be equivalent to identifying an existing account.

The method then proceeds to determine (120) that payment in the payment amount is due under the loan contract (generated at 100). A threshold required total asset value is then defined (130) for the linked account to ensure that following payment of the payment amount, the linked account would continue to have sufficient assets. Such a threshold may be defined based on, for example, a desired loan to value, or LTV, ratio. The desired loan to value ratio may be based on a policy relied on by the method, legal requirements for securitization, or a contractual requirement, among other bases. In a typical embodiment, the desired or required LTV ratio is 50%.

Once a threshold required total asset value is defined (at 130), such a threshold is applied to the linked account. Accordingly, the method confirms that an actual total asset value for the linked account is greater than the amount required based on the threshold required asset value (140).

Once sufficient assets are confirmed, the method initiates payment of the payment amount under the loan contract (150). In a typical embodiment, the linked account has no or few assets maintained as cash. Accordingly, following the payment of the payment amount, the linked account will typically have a negative cash balance (160) as a result of the payment. Following the payment of the payment amount, the method proceeds to initiate a sale of non-cash assets (170) such as stocks maintained at the linked account. Such a sale of non-cash assets eliminates the negative cash balance (180). Accordingly, the linked account may be a brokerage account associated with the system and method. Further, the sale of non-cash assets may not be immediate. Instead, the sale may be, for example, on the next available trading day. Note that stocks are just one example of a non-cash asset, but other non-cash assets are contemplated as well, such as crypto assets and NFTs.

It is noted that in some embodiments, the linked account may maintain a small cash balance. Accordingly, in some embodiments, and in some iterations of payment of the loan amount, the payment of the payment amount is initiated (at 150), but the resulting cash balance is still positive or zero. In such a scenario, no sale of non-cash assets (170) is required. For example, in some embodiments, a previous sale may have resulted in sufficient cash for multiple payments or non-cash assets, such as stocks, may generate dividend payments which may then be maintained as cash. Alternatively, in some embodiments, a user may populate the account with cash sufficient for payment of the payment amount, such that the account stays positive and no asset selloff is required. Similarly, the user may pay the negative balance prior to some deadline so as to avoid an undesired asset selloff.

If, after evaluating the total asset value for the linked account, the method determines that funds are insufficient (230), the method may attempt to pay the payment amount from cash holdings or the method may require an infusion of cash or assets by the user. If such a cash infusion is provided (240), thereby increasing the actual asset value, the total holdings may be evaluated again (at 140) to determine if payment is possible.

If no cash infusion is possible, the method may initiate liquidation of assets sufficient to pay back the loan (250). Alternatively, some agreed upon process may be implemented to ensure loan repayment.

Following payment of the payment amount (at 150) and elimination of any negative cash balance (180), the method may continue to manage the loan iteratively. Accordingly, the method would typically monitor the loan (190), including payment due dates, and determine if additional payments are or will come due on the loan (generated at 100). Once any such payment is determined to be due (at 120), the steps discussed above repeat.

Accordingly, the method may define a threshold required asset value for the linked account (at 130) and confirm that an actual asset value for the linked account is greater than the threshold required asset value (at 140). The method may then proceed to make the payment due in the payment amount (at 150) thereby generating a negative cash balance (at 160) and then sell assets (at 170) to clear the negative balance (at 180). Typically, calculation of the threshold required asset value (at 140) is required prior to any payment, since the requirement is often tied to the amount owned and therefore can change as the loan gets paid down. Similarly, confirmation of sufficient assets (at 140) is required at each iteration, since asset value changes frequently.

In some embodiments, as noted above, the account linked (at 110) is an account used for assets securitized for use in backing the loan (generated at 100). Accordingly, the total asset value for the linked account is a total value of assets nominated or otherwise designated for use in securitization. In other embodiments, a subset of assets in a particular account are nominated for use in securitization. In such an embodiment, the method generates a sub-account for maintaining those assets, or otherwise defines those nominated assets such that they represent the total asset value for the linked account for the purpose of the relevant calculations.

Typically, assets nominated for use in securitization (when such nomination is limited to a particular subset of assets) or the linked account as a whole (when the entire linked account is pledged) are locked in order to back the loan (at 100). In some embodiments, the method generation of the loan contract (at 100) includes the implementation of a lien against the assets. In other embodiments, the overall value of a pledged portfolio must be maintained by a user, but specific assets may be utilized or transacted.

As discussed in more detail below, the loan contract (generated at 100) can be generated in a variety of different ways. However, upon generation of the loan contract, the method typically confirms that the linked account has, or will have, sufficient assets to back the loan contract. In some embodiment, once such a contract exists, a user can request increased credit (at 200). Upon such a request, the method may then determine an updated threshold required asset value (210) based on a hypothetical increased loan value.

If the assets in the linked account are determined (at 220) to be sufficient to support the increased credit, such increased credit is issued and the method generates an updated loan contract (at 100) specifying updated payment terms, such that the payment terms for the method are redefined as the updated payment terms.

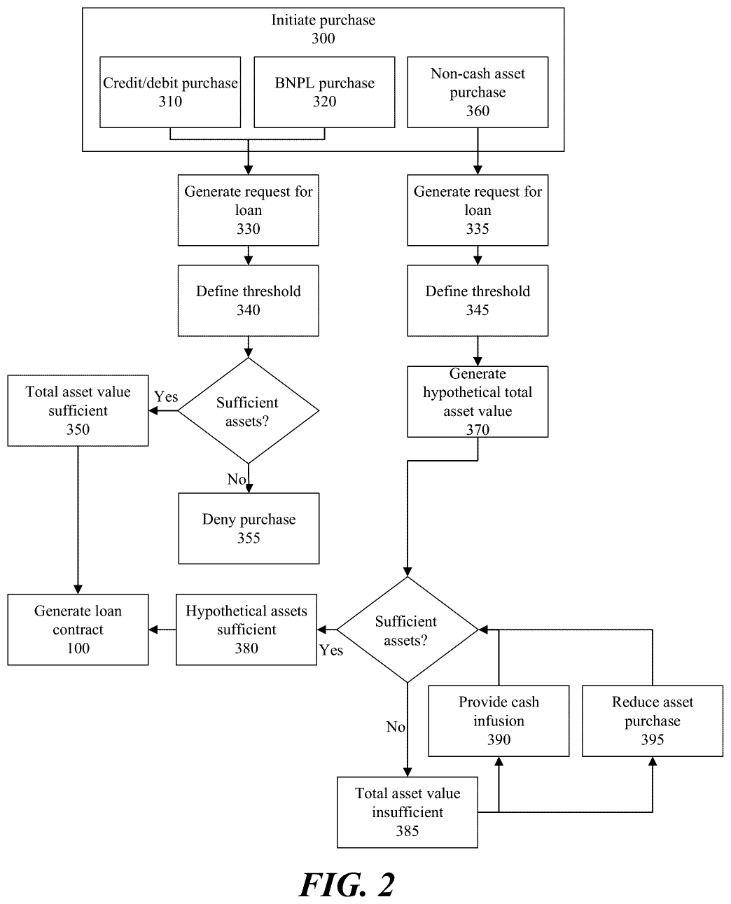

FIG. 2 illustrates a method for generating a loan in the context of the method for loan management of this disclosure. As shown, the loan contract generated (at 100) in FIG. 1 can be generated within the context of the method and system described here in a variety of ways.

In some embodiments, a user may initiate a purchase (300) linked to the system and method for loan management. Such a purchase may be initiated in various ways, including a credit card or debit card purchase (310), where usage of the credit card or debit card is linked to the system and method. Similarly, the purchase may be initiated in a “buy now pay later” (BNPL) platform (320) linked to the system and method.

In such an embodiment, upon initiating the purchase (at 300), the system generates a request for a loan (at 330). Such a request may be automatically generated and may include terms defined in a contract associated with the credit card, debit card, or BNPL platform.

When the method receives and processes the request for the loan (at 330), the request includes at least a desired loan amount. The method then proceeds to define a threshold required total asset value (340) for a linked account based on the desired loan amount. The method then proceeds to confirm (350) that an actual total asset value for the linked account is greater than the threshold required asset value and generates the loan contract (at 100) based on the request for the loan. If sufficient assets are not available, the system may then deny the purchase (355).

As discussed above, loan terms can be modified based on a request for additional credit (at 200). Accordingly, the request for a loan described herein (at 330) may be for the creation of a line of credit or the expansion of a line of credit. Accordingly, in the context of a credit card, for example, each purchase initiated by a user would trigger a new request for a loan (at 330), which would then correspond to the request for additional credit (at 200).

In some embodiments, the initiation of a purchase (at 300) may be for non-cash assets (360) to be deposited in the linked account. For example, a user may attempt to purchase stocks or other shares of assets (360) to be held in the linked account. In such an embodiment, the method receives the request for the loan (at 335) prior to generating the loan contract (at 100). The request for the loan then comprises a desired loan amount for purchasing the non-cash assets.

The method proceeds to define a threshold required total asset value (at 345) based on the desired loan amount. However, instead of confirming that the actual total asset value for the linked account is greater than the threshold required (at 350) or denying the purchase (at 355), the method instead generates a hypothetical total asset value (370) for the linked account based on the addition of the non-cash assets being purchased (at 360). Accordingly, the hypothetical total asset value may comprise a sum of the actual total asset value for the linked account at the time of the request and the non-cash assets associated with the attempted purchase.

The method then confirms that the hypothetical total asset value for the linked account is greater than the threshold required asset value (at 380) and generates the loan contract based on the request for the loan (at 100). In some embodiments, the non-cash assets being purchased may be secured following the purchase by a lien or may be otherwise locked for the term of the loan.

As discussed above, in some embodiments, the loan is backed by multiple assets or a complete portfolio held in the linked account, where the linked account as a whole is nominated for securitization. In such embodiments, the hypothetical total asset value for the linked account is a hypothetical value of the non-cash assets the user has attempted to purchase (at 360) added to a value of assets, whether they be cash or non-cash assets, already in the linked account.

In some embodiments, the user may have insufficient hypothetical assets for the proposed non-cash asset purchase (385). In such an embodiment, the user may provide a cash infusion (390) or may reduce the proposed asset purchase (395) in order to avoid having the purchase denied.

In other embodiments, the non-cash assets being purchased (at 350) are themselves the assets to be securitized in the linked account. In such an embodiment, the purchasing user would typically contribute a portion of the cost of the non-cash assets to be purchased. Accordingly, the desired loan amount is less than the value of the non-cash assets being purchased.

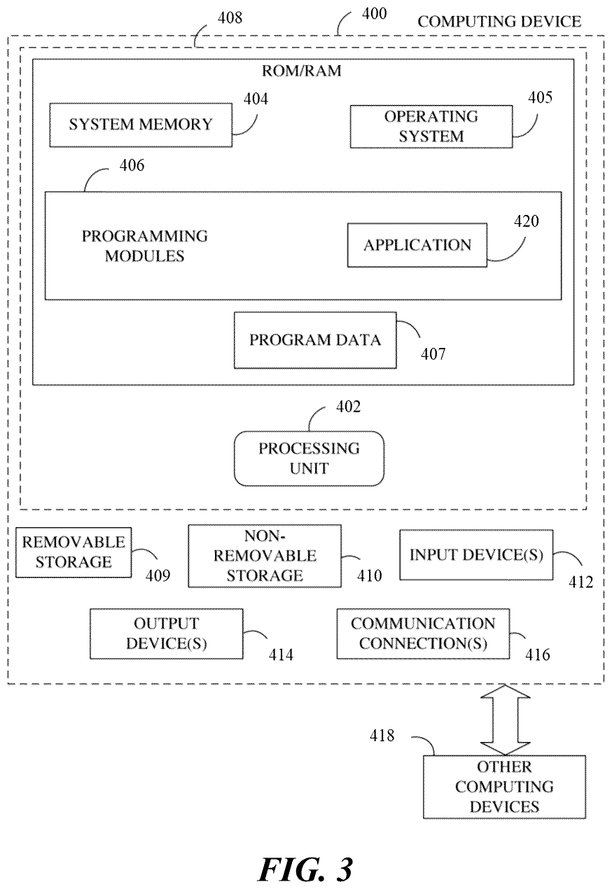

FIG. 3 illustrates a schematic system architecture for implementing the method of FIGS. 1 and 2.

A system implementing the methods described may include a computing device or cloud service, such as computing device 400. In a basic configuration, computing device 400 may include at least one processing unit 402 or processing circuitry and a system memory 404. Depending on the configuration and type of computing device, system memory 404 may comprise, but is not limited to, volatile (e.g., random-access memory (RAM)), non-volatile (e.g., read-only memory (ROM)), flash memory, or any combination. System memory 404 may include operating system 405, one or more programming modules 406, and may include program data 407. Operating system 405, for example, may be suitable for controlling computing device 400's operation. This basic configuration is illustrated in FIG. 3 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 3 by a removable storage 409 and a non-removable storage 410. Computer storage media may include volatile and nonvolatile, removable and non-removable media implemented in any method or technology for storage of information, such as computer-readable instructions, data structures, program modules, or other data. System memory 404, removable storage 409, and non-removable storage 410 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, a location sensor, a camera, a biometric sensor, etc. Output device(s) 414 such as a display, speakers, a printer, etc. may also be included. The aforementioned devices are examples and others may be used. Computing device 400 may also contain a communication connection 416 that may allow device 400 to communicate with other computing devices 418, such as over a network in a distributed computing environment, for example, an intranet or the Internet.

Communication connection 416 is one example of communication media. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 404, including operating system 405. While executing on processing unit 402, programming modules 406 (e.g., application 420 such as a media player or an audio plugin) may perform processes including, for example, one or more stages of methods, algorithms, systems, applications, servers, databases as described above. The aforementioned process is an example, and processing unit 402 may perform other processes.

Accordingly, the system may include computing device 400 which may comprise a system memory 404 for storing a plurality of instructions, processing circuitry, such as processing unit 402, for implementation of a loan system having a loan generation module and a loan repayment module, and a linked account accessible by the loan system. Outside systems and networks may be accessible by way of the communications connections 416.

The processing circuitry 402 couples with the memory 404 and is configured to execute the instructions from the program data 407 to generate, at the loan generating module, a loan contract specifying payment terms. The payment terms comprise a payment amount and at least one due date for a payment in the payment amount.

The processing circuitry 402 then defines, at the loan generation module, an association with the linked account, where the linked account contains non-cash assets to be used for loan repayment. The processing circuitry 402 then determines, at the loan repayment module, that payment in the payment amount is due under the loan contract.

When payment comes due, the system defines, at the loan repayment module, a threshold required total asset value for the linked account and confirms, at the loan repayment module, that an actual total asset value for the linked account is greater than the threshold required asset value.

The system then initiates payment by the loan repayment module of the payment amount under the loan contract, the payment resulting in a negative cash balance associated with the linked account. The method then initiates, at the loan repayment module, a sale of non-cash assets in the linked account, thereby eliminating the negative cash balance.

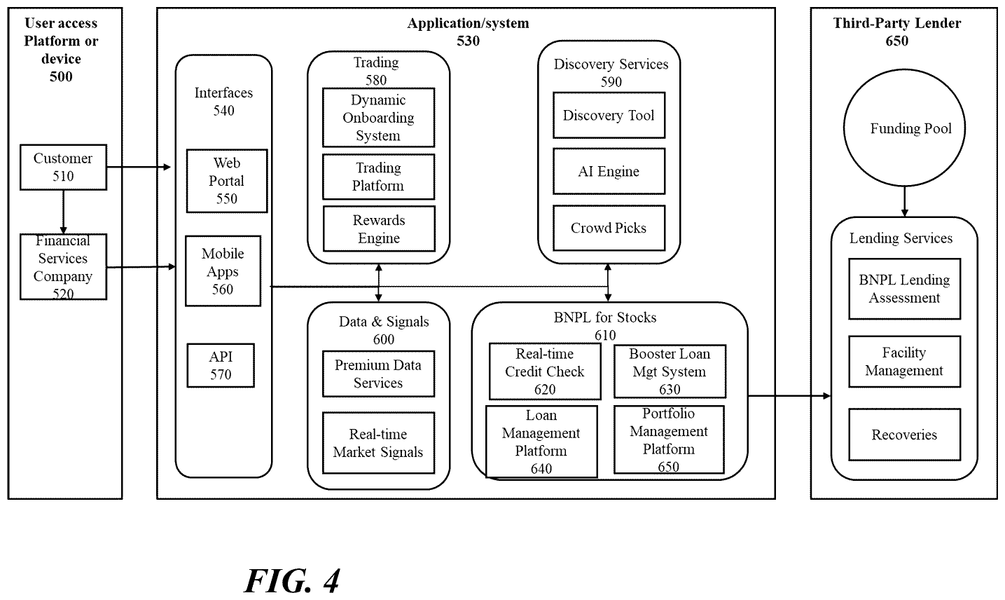

FIG. 4 shows a schematic representation of a system architecture for implementing the methods described herein. As shown, a user may access the system through a user access platform or device 500. Such access may be directly by a customer 510 as the user of the platform, or it may be by the customer 510 by way of a financial service company 520.

In any event, the user access platform or interface device 500 may then interact with the application/system 530 on which the method described is primarily being implemented. Such an application/system 530 may be an application on a user device, such as computing device 400, or it may be a server based or cloud based platform. In any event, the user access platform or device 500 may then interact with the application or system 530 by way of an appropriate interface 540, which may be, for example, a web portal 550, a mobile application 560, or an API 570.

The interfaces 540 provide access to a system trading module 580, discovery services 590, data services 600, and a BNPL platform for stock purchasing 610. Many of the modules utilized by the methods described above and below are contained within the BNPL platform. Accordingly, the BNPL platform 610 may contain a real-time credit check module 620, a booster loan management system 620, a loan management platform 630, and a portfolio management platform 640.

The application or system 530 may then interact with a third-party lender platform 650 to implement the various features described above. It is noted that while a third-party lender platform 650 is shown, a loan system operated by the provider of the main application or system 530 is contemplated as well.

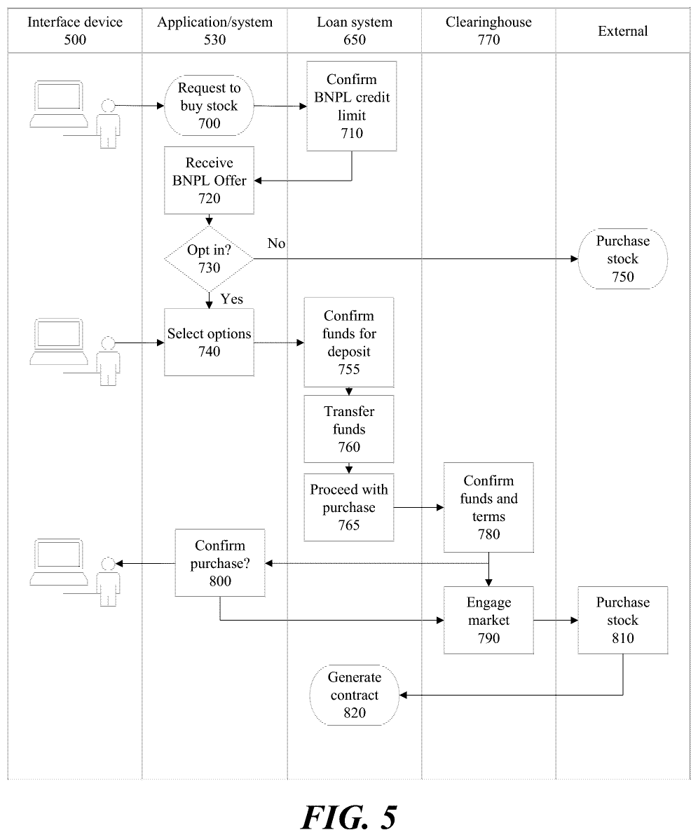

FIG. 5 shows a swim lane diagram for buying stock in a BNPL implementation in accordance with this disclosure. As shown, a user of the system 530 may access the system by way of their own device 500 and request to buy stock (700). Typically, a user of the system 530 maintains a linked cash management account (CMA) associated with the loan system 650. Further, in many implementations, the user of the system 530 maintains a linked asset portfolio, such as a stock portfolio, associated with the loan system 650. The system 530 may then access the loan system 650 to confirm the user's BNPL loan limit (710) and receive a BNPL offer (720) from the loan system 650.

The user may then choose to accept the BNPL offer (720) and opt in to such a loan (730), in which case the user can select various options associated with such a loan (740). Alternatively, the user may opt out of the loan offer (at 730) and instead choose to purchase stock directly (750) with cash or may choose not to proceed with the purchase at all.

If the user opts in (at 730), the user selects various options associated with the loan (at 740) and proceeds to generate a corresponding request. Among other options associated with the loan, a user may select or be assigned a deposit amount required for the user to generate the corresponding BNPL loan. Accordingly, the loan system 650 then confirms that adequate funds are available in the user's cash management account (750) and transfers the funds from the user's cash management account to a BNPL account (760) prior to proceeding with the purchase (765).

The loan system 650 then accesses a clearinghouse 770 for executing the actual purchase. The clearinghouse confirms (780) that the funds are available between the cash management account and the BNPL account, and then proceeds to engage the market (790). In some embodiments, prior to engaging the market, the clearinghouse 770 may seek a final confirmation (800) from the user (at 500) to proceed with engaging the market (at 790). Once confirmed, the clearinghouse 770 proceeds to purchase stock 810 on behalf of the user. The loan system 650 then generates the negotiated BNPL contract (820) upon confirming that the stock has been purchased (at 810). As part of the generation of such a negotiated BNPL contract, the system may generate a lien on the assets purchased.

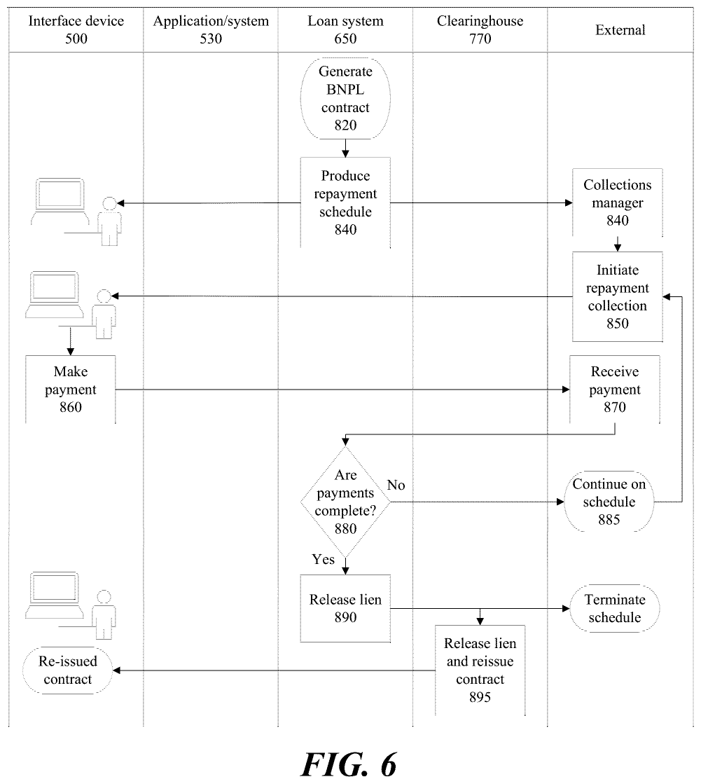

FIG. 6 shows a swim lane diagram for repayment in a BNPL implementation in accordance with this disclosure. Once a BNPL contract has been generated (at 820), the method proceeds to generate a repayment schedule (830) so that the loan system 650 can facilitate repayment of the loan by the user. Accordingly, the generated repayment schedule (830) is sent to both the user to access at their own interface device 500 and to a third-party collections manager (at 840) outside of the main platform.

On each repayment date, the third-party collections manager initiates the repayment collection (850), the user initiates a corresponding repayment (860), and the third-party collections manager receives the payment (870).

Following each such payment, the system then determines whether BNPL payments are complete (880). If not, the third-party collections manager continues on the established schedule (885) and proceeds to monitor the generated repayment schedule and, upon determining that a payment is due, initiating a corresponding repayment collection (at 860). If payments are complete, the loan system 650 instructs the clearinghouse 770 to release the corresponding lien (890) and reissue the purchase contract (870) and instructs the third-party collections manager to terminate the corresponding schedule (895). The clearinghouse 770 then provides the reissued contact to the user at the user's access point 500.

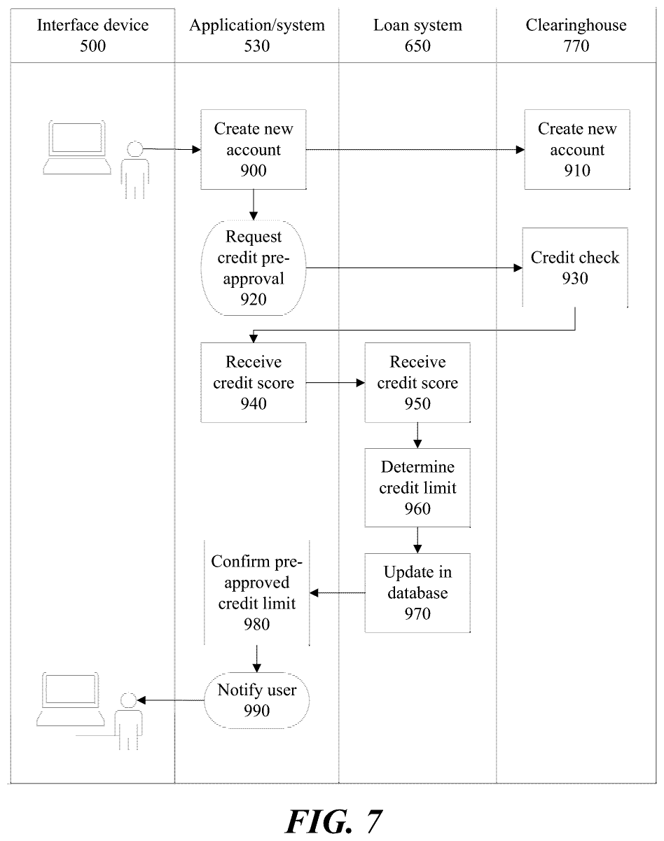

FIG. 7 shows a swim lane diagram for evaluating user credit in a BNPL implementation in accordance with this disclosure. As shown, upon accessing the application/system 530 implementing the methods described for the first time, a user accessing the system at an interface device 500 may create a new account (900). As part of the account creation process, the user may initiate and fund a cash management account (910). Such a cash management account, or CMA, may be set up by the clearinghouse 770 and associated with the user's account, and may be used for facilitating fund transfers between different participants in transactions.

Following initiation of an account, a user may request pre-approval for credit (920), which credit may then be used to support BNPL purchases. Such a pre-approval may be automatically initiated upon the initiation of an account, or it may be performed upon request by a user. The clearinghouse 770 may then perform a credit check (930), and the user's credit score may then be provided to the system 530. Upon receiving the credit score (940), the system 530 may provide the same to the loan system 650 (at 950) which then determines a credit limit (960) which is updated and maintained in a system database (970). The pre-approved credit limit is then confirmed to the system 530 (at 980) and the user is notified of the same (990).

In some embodiments, the system 530 and associated platform incorporates various methods of adjusting the user's credit limit. Accordingly, upon a request from a user, the system 530 may check the user's current CMA balance and outstanding BNPL debt, and may then utilize the clearinghouse 770 to perform additional credit checks and, if appropriate, adjust the user's credit limit.

Similarly, in some embodiments, the system 530 may proactively monitor user credit limits and, when appropriate, initiate an adjustment process. In such scenarios, the system 530 may determine that some subset of users are eligible for an increased credit limit, after which the system may notify only those users whose credit limits were adjusted.

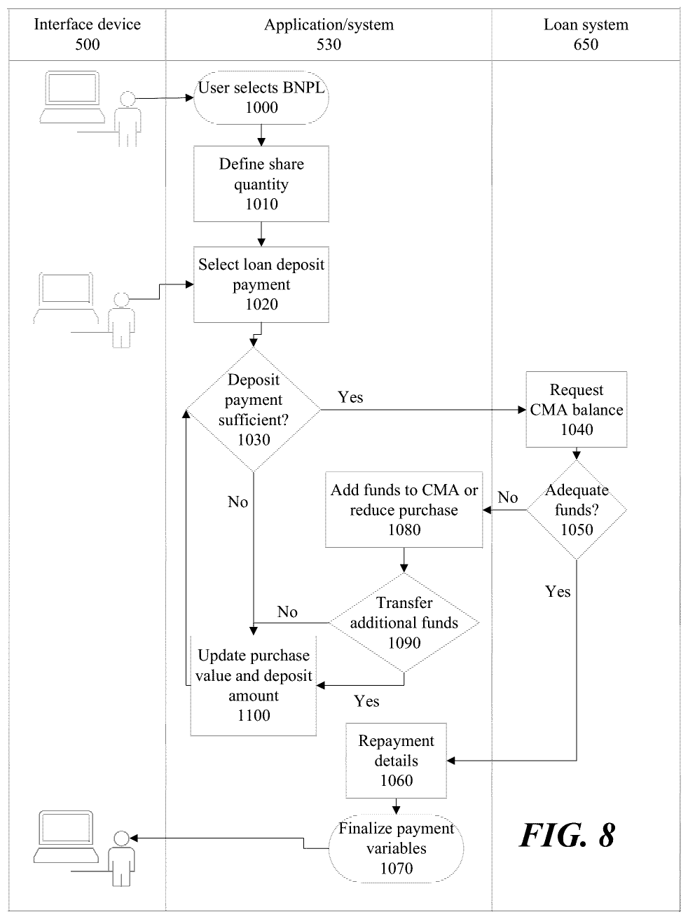

FIG. 8 shows a swim lane diagram for selecting repayment variables in a loan contract in accordance with this disclosure. Accordingly, a user may furst choose to use the BNPL service (1000) and indicate the same to the system 530 at the user device 500. After such a selection, the system asks the user to define, in the case of a stock purchase, a share quantity or value to be purchased (1010). The user then nominates an initial deposit that will be used as an initial payment for the BNPL loan (1020).

The system 530 then determines if the proposed deposit payment is sufficient (1030) in order to support the proposed stock purchase. In a typical embodiment, in order to meet loan to value ratio requirements (LVR), the deposit value should be between 50% and 80% of the value of the requested purchase. Upon confirming that the proposed deposit payment is sufficient, the loan system 650 requests the cash management account balance associated with the user (1040), and determines if the account contains adequate funds (1050). If the system 530 does not determine that the proposed deposit payment is sufficient (at 1030), the method may then require that the user update purchase value and/or deposit amount (1100) prior to proceeding.

If the CMA account contains adequate funds, the method proceeds to generate repayment details (1060). Once all payment variables are finalized (1070), the method may proceed to generate an appropriate BNPL contract in accordance with other methods described in this disclosure.

If the CMA account does not contain adequate funds, the loan system 650 may indicate the same to the system 530, and the user may be presented with an option transfer additional funds to the CMA or to reduce the purchase loan value (1080) by modifying the share quantity or value to be purchased. Accordingly, the user may transfer additional funds (1090) and/or update the purchase value and deposit amount (1100). Once the user updates the proposed deposit payment, the system 530 may again determine if the proposed deposit payment is sufficient (1030).

In various implementations described herein, the methods may utilize a clearinghouse 770 to buy and sell shares of assets, such as stocks. The clearinghouse 770 may then access a stock market or other exchange to execute on such purchases or sales. Such purchases may take a variety of forms compatible with the various methods described herein. Similarly, processes associated with accounting may be implemented in typical ways, and appropriate reconciliations processes may be implemented at various times to ensure that funds are moved between accounts as appropriate. Accordingly, the system may implement a daily reconciliation process to ensure that funds are properly sent to customers or to the clearing house.

The term “data processing apparatus” and like terms encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Computers may further be provided in other forms, such as in the form of handheld devices or smartphones, as well as in the form of tablet devices. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser. A device for providing interaction with a user may be referred to as a user interface device.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A method for loan management, the method comprising:
generating a loan contract specifying payment terms, the payment terms comprising a payment amount and at least one due date for a payment in the payment amount;
defining a linked account, the linked account containing non-cash assets to be used for loan repayment;
determining that payment in the payment amount is due under the loan contract;
defining a threshold required total asset value for the linked account;
confirming that an actual total asset value for the linked account is greater than the threshold required asset value;
initiating payment of the payment amount under the loan contract, the payment resulting in a negative cash balance associated with the linked account;
initiating a sale of non-cash assets in the linked account, thereby eliminating the negative cash balance.

2. The method of claim 1, wherein upon eliminating the negative cash balance, the method continues to monitor payment due dates under the loan contract, and upon determining that payment in the payment amount is due under the loan contract, defines a threshold required asset value for the linked account, confirms that an actual asset value for the linked account is greater than the threshold required asset value, initiates payment of the payment amount under the loan contract, and initiates a sale of assets in the linked account to eliminate any resulting negative cash balance.

3. The method of claim 1, wherein the total asset value for the linked account is a total value of assets nominated for use in securitization.

4. The method of claim 1, wherein the threshold required asset value for the linked account is defined based on a desired loan to value ratio.

5. The method of claim 4, wherein the desired loan to value ratio is 50%.

6. The method of claim 1, further comprising receiving a request from a user for increased credit, determining that assets in the linked account are sufficient to support the increased credit, issuing the increased credit, and generating an updated loan contract specifying updated payment terms, such that the payment terms for the method are redefined as the updated payment terms.

7. The method of claim 1 further comprising:
receiving a request for a loan prior to generating the loan contract, the request for a loan comprising a desired loan amount,
defining a threshold required total asset value for the linked account based on the desired loan amount;
confirming that an actual total asset value for the linked account is greater than the threshold required asset value; and
generating the loan contract based on the request for the loan.

8. The method of claim 7, wherein the request for a loan is automatically generated based on a purchase.

9. The method of claim 8, wherein the method for loan management is associated with a credit or debit card, and wherein usage of the credit or debit card to execute a purchase automatically generates the request for a loan.

10. The method of claim 8, wherein the request for a loan is generated in a buy now pay later platform.

11. The method of claim 1 further comprising:
determining that a user has attempted to purchase non-cash assets to be deposited in the linked account;
receiving a request for a loan prior to generating the loan contract, the request for a loan generated based on the attempted purchase of non-cash assets, and the request for a loan comprising a desired loan amount for purchasing the non-cash assets,
defining a threshold required total asset value for the linked account based on the desired loan amount;
confirming that a hypothetical total asset value for the linked account is greater than the threshold required asset value, the hypothetical total asset value comprising a sum of an actual total asset value for the linked account and the non-cash assets associated with the attempted purchase; and
generating the loan contract based on the request for the loan.

12. The method of claim 11, wherein the hypothetical total asset value for the linked account is a hypothetical value of the non-cash assets the user has attempted to purchase, and wherein the desired loan amount is less than the value of the non-cash assets being purchased.

13. The method of claim 11, wherein the hypothetical total asset value for the linked account is a hypothetical value of the non-cash assets the user has attempted to purchase added to a value of assets already in the linked account nominated for securitization.

14. The method of claim 1, wherein the non-cash assets are stocks and wherein the linked account is a brokerage account.

15. The method of claim 1, wherein the initiation of the sale of non-cash assets in the linked account is on the next available trading day.

16. A system for loan management, the system comprising:
a memory for storing a plurality of instructions;
processing circuitry implementing a loan system having a loan generation module and a loan repayment module; and
a linked account accessible by the loan system,
wherein the processing circuitry couples with the memory and is configured to execute the instructions to:
generate, at the loan generation module, a loan contract specifying payment terms, the payment terms comprising a payment amount and at least one due date for a payment in the payment amount;
define, at the loan generation module, an association with the linked account, the linked account containing non-cash assets to be used for loan repayment;
determine, at the loan repayment module, that payment in the payment amount is due under the loan contract;
define, at the loan repayment module, a threshold required total asset value for the linked account;
confirm, by the loan repayment module, that an actual total asset value for the linked account is greater than the threshold required asset value;
initiate payment by the loan repayment module of the payment amount under the loan contract, the payment resulting in a negative cash balance associated with the linked account, and
initiate, by the loan repayment module, a sale of non-cash assets in the linked account, thereby eliminating the negative cash balance.
